(19) United States
(12) Patent Application Publication
(10) Pub. No.: US 2003/0174260 A1
(43) Pub. Date: Sep. 18, 2003

(54) Visual display device with display cell

(76) Inventors: Gilles Labrousse, Bordeaux (FR); Pascal Capdepuy, St Jean D'Illac (FR)

Correspondence Address: Lowe Hauptman, Gilman & Berner, Suite 310, 1700 Diagonald Road, Alexandria, VA, 22314, US

(21) Appl. No.: 10/333,251

(22) PCT Filed: Jul. 10, 2001
(86) PCT No.: PCT/FR01/02226

(30) Foreign Application Priority Data
Jul. 21, 2000 (FR) 00/09633

(51) Int. Cl. G02F 1/1333

(52) U.S. Cl. 349/58

(57) ABSTRACT

The invention relates to display devices comprising one or more display cells.

It is a display device comprising, as a minimum, a display cell (1), a frame (8) designed to receive the cell (1), and a system (11, 12, 13, 15, 16) for mechanically holding the cell (1) with respect to the frame (8), the mechanical holding system (11, 12, 13, 15, 16) comprising several stops (11, 12, 13) arranged in such a way as to define without maintaining a unique position of the cell (1) with respect to the frame (8) in a mean plane (XY) of the cell (1) and at least one block (15, 16) arranged in such a way as to be able, in combination with the stops (11, 12, 13), to maintain said position.

The invention is applied for example to display devices comprising one or more liquid crystal screens.

The invention relates to display devices comprising one or more display cells. The display cell is preferably essentially flat. The display cell is advantageously a liquid crystal screen. The display device also comprises a frame designed to receive the display cell and a system for mechanically holding the display cell with respect to the frame.

In a first prior-art approach, it is known practice to clamp the display cell between two parts of the frame in order to hold the display cell in position. On both sides of the display cell, between the display cell and the part of the frame designed to clamp the display cell, is a gasket. The display cell is therefore clamped by the parts of the frame via gaskets.

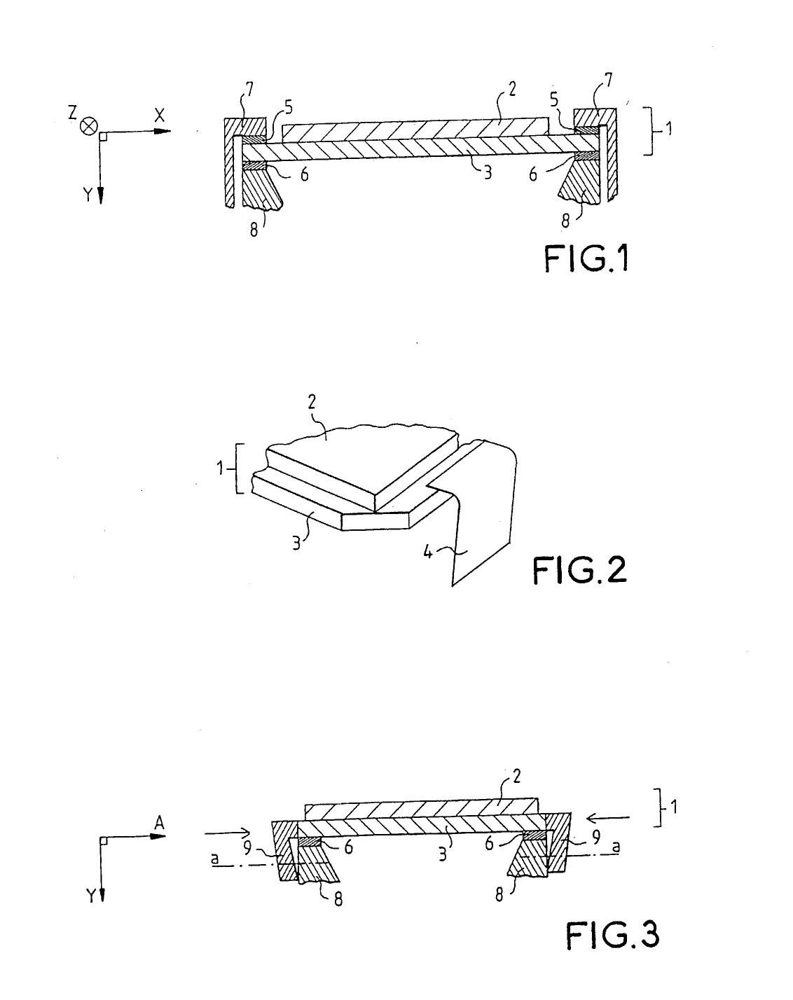

FIG. 1 shows diagrammatically a cross section through a part of a device according to the first prior-art approach. The display cell 1 is a liquid crystal screen comprising two glass plates, a top plate 2 and a bottom plate 3. The bottom plate 3 is generally referred to as the TFT plate while the top plate 2 is generally known as the back electrode. The liquid crystals lie between the bottom plate 3 and the top plate 2. The screen 1 is illustrated in cross section from the side. The frame has two parts, a top part 7 and a bottom part 8. The bottom plate 3 of the screen 1 is clamped between the top part 7 and the bottom part 8 of the frame via gaskets. The top gasket 5 is clamped between the top part 7 of the frame and the bottom plate 3 of the screen 1 while the bottom gasket 6 is clamped between the bottom plate 3 of the screen 1 and the bottom part 8 of the frame. The mean plane of the screen 1, which is essentially flat, is the plane XZ. The direction of the clamping force is the direction Y. The resilient gaskets enable dimensional tolerances to be absorbed between the parts 7 and 8 of the frame which clamp and so encapsulate the screen 1.

The display cell, particularly at the sites of the electrical connections attaching it to the rest of the device, is fragile. To protect the display cell when the display device is subjected to stresses such as for example vibrations, it is advisable to limit the possibility of movement of the display cell, particularly in a plane parallel to a mean plane of the display cell, or to the mean plane of the display cell if the latter is essentially flat. Damage to or destruction of the electrical connections can in this way be avoided, even where the display device is to be subjected to severe operational stresses such as very intense vibrations in the preferred case of liquid crystal screens for display devices used for example in instrument panels for aircraft, especially military aircraft.

FIG. 2 shows diagrammatically, in perspective, an electrical connection of this kind in the preferred case in which the display cell is a liquid crystal screen, this highlighting the problem posed by a display device according to the first prior-art approach. The screen 1 comprises a top plate 2 and a bottom plate 3. An electrical connection 4, known as a tab, electrically connects the bottom plate 3 to the rest of the display device. The tab consists of a flexible circuit on which an electronic chip, has been deposited. When movements occur in the mean plane of the screen 1 that are excessive, or excessively violent, when the display device is subjected to large stresses such as for example fierce vibrations, the tab 4 may tear, which will damage and even destroy the electrical connection between the screen 1 and the rest of the display device.

In a second prior-art approach, it is known practice to use corner clamps with associated tightening screws. Four corner clamps are arranged, one at each of the four corners of a display cell. The clamps clamp the display cell and are immobilized by tightening screws. One drawback is that the position of the display cell with respect to the frame is undefined, meaning that this position depends on the distribution of the tightening forces at the four corners. This creates problems particularly when a touch keyboard is associated with the display cell because the selection keys and the image displayed on the display cell may not be correctly aligned with each other. A second drawback is the fact that defects can be introduced into the image displayed by the display cell, these defects being the result of the stresses exerted by the tightening screws where their tightening axes are parallel to the respective axes of constraint of the display cell by the clamps to which these tightening screws are connected. Such defects are for example moiré effects visible on the display cell.

FIG. 3 shows diagrammatically a cross section through a part of a display device according to the second prior-art approach. The display cell 1 is a liquid crystal screen comprising a top plate 2 and a bottom plate 3. The bottom plate 3 rests on a bottom frame part 8 via a bottom gasket 6. The screen 1 is shown in diagonal section, the axis A being parallel to the cutting diagonal. Clamps 9 clamp the screen 1 by exerting pressure along clamping axes parallel to the axis A of the diagonal of the screen 1, as shown by arrows in FIG. 3. The tightening axes a of the tightening screws (not shown in FIG. 3 for reasons of simplicity) are parallel to the axis A and therefore to the clamping axes. The tightening axes a are shown in chain line.

The invention provides a solution in which the possible movements of the display cell in a mean plane of the display cell or in the mean plane of the display cell if the latter is essentially flat, that is, in directions parallel to the mean plane of the display cell, are limited compared with the possible movements in display devices of the first prior-art approach discussed above, movements which occur when the display cell is for example subjected to vibrations. The invention also provides a solution in which the position of the display cell with respect to the frame and therefore with respect to the rest of the display device is defined more precisely than in the case of the second prior-art approach discussed above. The invention also provides a solution in which the stresses applied to the display cell in the mean plane of the display cell are smaller than the stresses applied in the display device according to the second prior-art approach discussed above.

The invention provides a display device comprising, as a minimum, a display cell, a frame designed to receive the cell, and a system for mechanically holding the cell with respect to the frame, the device being characterized in that the mechanical holding system comprises several stops arranged in such a way as to define without maintaining a unique position of the cell with respect to the frame in a mean plane of the cell and at least one block arranged in such a way as to be able, in combination with the stops, to maintain said position.

The display device comprises one or more display cells held in position by a mechanical holding system that forms the subject of the invention. Each display cell is held in position by a mechanical holding system that forms the subject of the invention in a mean plane of the display cell; the system for mechanically holding the display cell therefore holds the display cell in two directions in space, while means which are not the subject of the invention hold it in the third direction of space.

The display cell is preferably essentially flat, that is, one of its three dimensions, which will be termed the thickness, is substantially less than the other two dimensions, i.e. the thickness is less than one half of each of the other two dimensions, thus together forming the mean plane of the cell, in which mean plane the possible movements must be limited. Although this is not the subject of the invention, the cell is also held in position in a direction at right angles to the mean plane of the cell, that is, in the direction of its thickness.

Particularly in the case of an essentially flat cell, it is held in the direction perpendicular to the mean plane of the cell, either insufficiently to immobilize the cell so that the cell's electrical connections are not damaged by vibrations, for example, or too tightly for the applied stress not to damage the cell or disturb the image displayed by the cell. To take an example, a liquid crystal screen is essentially flat whereas a conventional cathode-ray tube is not essentially flat.

A frame is designed to receive the cell. The cell is held in position with respect to this frame by a mechanical holding system that forms the subject of the invention, in directions parallel to a mean plane of the cell or to the mean plane of the cell if the latter is essentially flat. Throughout the remainder of the text, for reasons of simplicity, and unless otherwise indicated, no distinction will be made between “a” and “the” mean plane of the display cell, whether or not the latter is essentially flat. This mechanical holding system comprises a number of stops arranged in such a way as to define a unique position of the cell with respect to the frame in the mean plane of the cell. The stops may belong to the frame, or to the cell, or some to the frame and some to the cell.

The stops preferably belong to the frame. There is then only one position of the cell in which the cell is in contact with all of the stops. This contact may occur either directly or indirectly, as for example via stop protectors arranged between the stops and the cell. The position of the cell, when the cell is in contact with all the stops, is defined but not maintained, meaning that the cell is not immobilized in this position. One or more blocks are placed in contact with the cell to immobilize the cell in the position already defined by the stops. It is the combination of the block or blocks and the stops which makes it possible to immobilize the cell in the position already defined by the stops. The unique position already defined by the stops does not depend on the distribution of tightening forces because it is defined before the block or blocks are tightened.

A clearer understanding of the invention and other features and advantages will be gained from the following description and from the attached drawings, given by way of examples, in which:

FIG. 1 shows diagrammatically a cross section through a part of a display device in accordance with the first prior-art approach;

FIG. 2 shows diagrammatically a perspective view highlighting the problem posed by a display device in accordance with the first prior-art approach;

FIG. 3 shows diagrammatically a cross section through a part of a display device in accordance with the second prior-art approach;

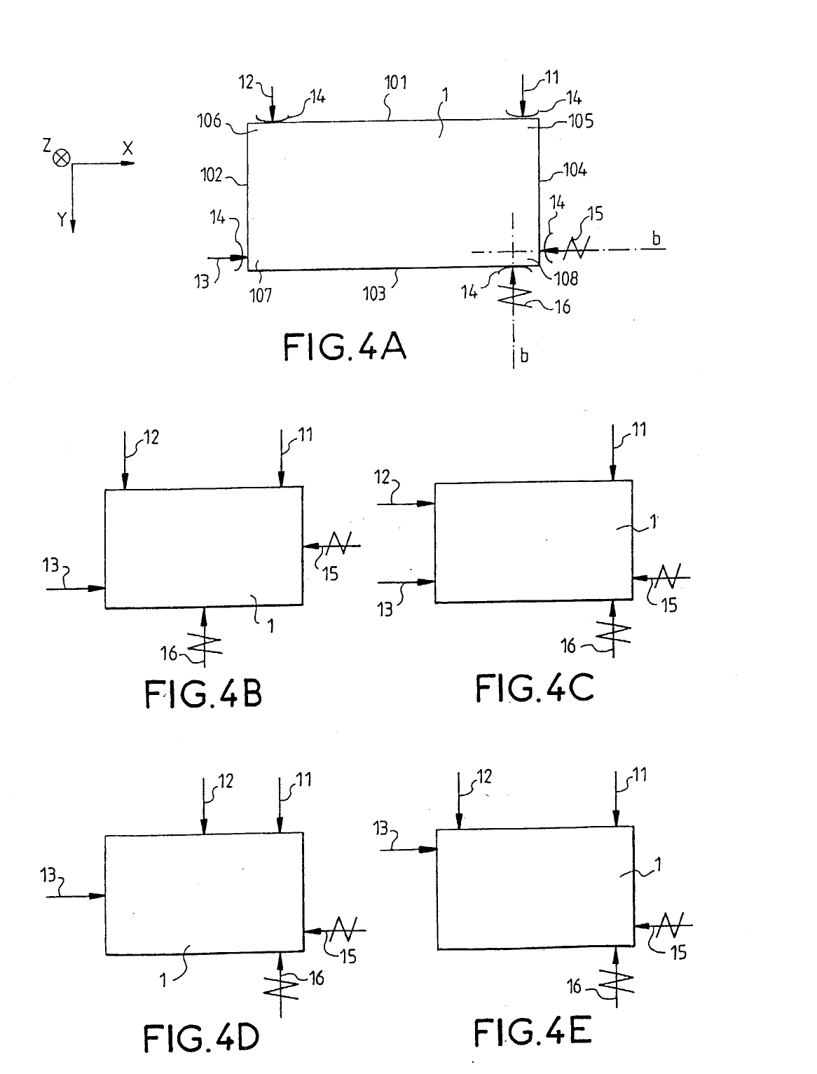

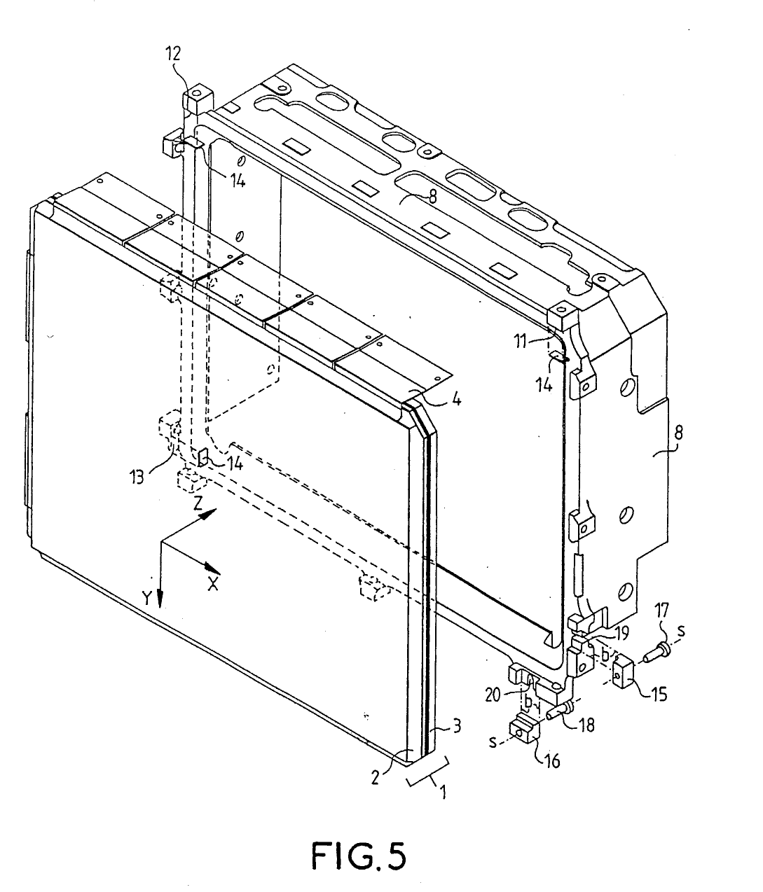

FIG. 4A shows diagrammatically a top view of a first preferred arrangement of the stops and blocks around the display cell in a display device according to the invention;

FIGS. 4B to 4E show-respective top views of other arrangements of the stops and blocks around the display cell in a display device according to the invention; and

FIG. 5 shows diagrammatically an exploded view of a preferred embodiment of part of a display device according to the invention.

For optimal stability of the position defined by the stops, there are preferably three of these stops and the projections of the stops in the mean plane of the cell are preferably not aligned. In the mean plane of the display cell, the display cell has two degrees of freedom in translational movement and one degree of freedom in rotation. Thus, in the mean plane of the display cell, two of the stops serve to eliminate one of the degrees of freedom in translational movement and the degree of freedom in rotation, while the third stop, which is not aligned with the other two, serves to eliminate the other degree of freedom in translational movement. In order to simplify the design and implementation of the stops, the stops advantageously all belong to the frame. The stops may take the form of for example protrusions formed in the (preferably metal) frame.

Each stop is preferably provided with a stop protector of semi-rigid material. The reason for this is that in the preferred case of a display device comprising one or more liquid crystal screens, the frame is, for example, metallic while the screen is generally made of glass. In operational mode, in other words when the display device is likely to be subjected to vibrations, this direct contact between the glass of the screen and the metal of the frame could break the glass of the screen, especially if the level of vibrations is high. The stop protectors of semi-rigid material reduce this risk of breakage. A semi-rigid material is a material that is not too rigid, so as not to risk breaking the glass of the screen, and not too soft, so that the resulting authorized movements of the cell in its mean plane do not break the electric connections of the cell to the rest of the display device. The semi-rigid material is advantageously a plastic such as for example MELINEX (registered trademark).

In order to reduce the stresses applied to the display cell, especially if the latter is essentially flat and might therefore bow, the tightening axis of each block is preferably not parallel to the axis of constraint of the cell by said block. The position defined by the stops can thus be maintained by the block or blocks without the latter exerting excessive stresses on the cell that could damage the cell or disturb the image displayed by the cell. Particularly but not exclusively in the case of a liquid crystal screen, which is very fragile, in order to completely or almost completely eliminate the stresses applied by the block or blocks to the display cell, the tightening axis of the block is advantageously more or less orthogonal to the axis of constraint of the cell by said block. The stresses can be completely eliminated when the tightening axis is exactly orthogonal to the axis of constraint and the stresses are only almost completely eliminated when the tightening axis is not perfectly orthogonal to the axis of constraint. Particularly in the preferred case of a liquid crystal screen, in order to avoid the risk of breakage at a point of glass/metal contact between the glass of the screen and the metal of the frame, the material of the block is advantageously a plastic, for example polyamide.

FIG. 4A shows diagrammatically a top view of a first preferred arrangement of the stops and blocks around the display cell in a display device according to the invention. A display cell 1 of mean plane XY is in a unique position in the mean plane XY, which position is defined by the stops 11, 12 and 13. The stops 11, 12 and 13 do not eliminate the degree of freedom in translational movement of the cell 1 in the Z axis, this degree of freedom in the Z axis being eliminated by other means which are not the subject of the invention. When the cell 1 is in contact with stops 11 and 12, the only degree of freedom remaining in the mean plane XY is translation in the X axis, which degree of freedom is eliminated when the cell 1, while remaining in contact with stops 11 and 12, comes into contact with stop 13. Between the cell 1 and each stop 11, 12 or 13, is a stop protector 14. Two blocks 15 and 16 maintain this position defined by the stops 11, 12 and 13, each of the blocks 15 and 16 preventing movement of the cell 1 in one of the directions of the plane XY, that is in either of directions X and Y. The shape of the cell 1 is rectangular, having long sides 101 and 103 and short sides 102 and 104. Each stop 11, 12 and 13 is situated at one of the corners of the rectangle, that is at one of the respective corners 105, 106 and 107. The two blocks 15 and 16 are situated at the fourth corner 108 of the rectangle and are in contact with the third 103 and fourth 104 sides, respectively, of the rectangle. The two blocks 15 and 16 can be replaced by a single block with its end shaped to form a re-entrant angle or by a single block with a flat end if the fourth corner 108 of the rectangle is beveled off. The axes b of constraint of the cell 1 by the blocks 15 and 16 are shown in chain line. The stops 11, 12 and 13 can, like the blocks 15 and 16, have stop protectors 14. The stops are shown by arrows, with the tips of the arrows symbolizing the positions of the stops. The blocks are shown by arrows with a superimposed broken line, the points of the arrows symbolizing the place of contact between the blocks and the display cell.

FIGS. 4B to 4E show diagrammatically respective top views of other arrangements of the stops and blocks around the display cell in a display device according to the invention. The references of the stops 11, 12 and 13 and blocks 15 and 16 are the same as in FIG. 4A. The arrangement in FIG. 4B is as stable as that in FIG. 4A, but takes up more room. The arrangement in FIG. 4C is less stable than the arrangements in FIGS. 4A and 4B but is more stable than the arrangements in FIGS. 4D and 4E. The arrangement in FIG. 4D is less stable than the arrangements in FIGS. 4A, 4B and 4C but is more stable than the position in FIG. 4E. The arrangement in FIG. 4E is less stable than all the other arrangements of FIGS. 4A to 4D.

More generally, and independently of the preferred example shown in FIG. 4A, in the preferred case in which the shape of the cell 1 is rectangular in its mean plane XY, there are three stops 11, 12 and 13. Two stops 11 and 12 are in contact with a first side 101 of the rectangle, preferably the long side, the two stops 11 and 12 being situated in the vicinities of two corners 105 and 106, respectively, of the rectangle. The third stop 13 is in contact with a second side 102 of the rectangle that is not parallel, to the first side 101, the second side 102 being preferably the short side of the rectangle, and the third stop 13 being situated in the vicinity of a third corner 107 of the rectangle. “A stop is situated in the vicinity of a corner” means that the nearer this stop is to the corner the more stable its position, practical problems of implementation aside. Typically, when the stop is situated in the vicinity of a corner, the stop is closer to the corner than to the middle of a side of the rectangle.

In a preferred embodiment there are at least two blocks 15 and 16 which are in contact with the third 103 and fourth 104 sides, respectively, of the rectangle, the two blocks 15 and 16 being situated in the vicinity of the fourth corner 108 of the rectangle. In another embodiment there is a single block situated in the vicinity of the fourth corner 108 of the rectangle. If the fourth corner 108 is beveled off, the block rests against the beveled part of the fourth corner 108. If the fourth corner 108 is not beveled, the block will be in the shape of a re-entrant angle and will rest simultaneously against both the third 103 and fourth 104 sides of the rectangle.

FIG. 5 shows diagrammatically an exploded view of a preferred embodiment of part of a display device according to the invention. The display cell 1 is a liquid crystal screen comprising a top plate 2 and a bottom plate 3. The electrical connections 4 are tabs. The only part of the frame shown is the bottom part 8 of the frame on which the screen 1 rests. The position of the screen 1 is maintained by the stops 11, 12, 13, each covered by a stop protector 14. When the display device is assembled, the stop protectors 14 are each trapped between the corners of the screen 1 on the one hand, and the stops 11, 12 and 13 on the other. The blocks 15 and 16 have respective axes of constraint b of the screen 1 which are orthogonal to the respective tightening axes s of these blocks 15 and 16, which are tightened by respective tightening screws 17 and 18. The axes of constraint b and the tightening axes s are shown in chain line. The tightening screws 17 and 18 engage in respective oblong holes 19 and 20 to tighten the blocks 15 and 16, respectively. All sides of the display device are preferably defined with reference to the stop 12, which among other things optimizes the alignment between the keys of the keyboard and the image displayed, in the case in which a touch keyboard is superimposed on the screen 1.

The display device according to the invention is preferably used in an aircraft instrument panel, and more particularly in the instrument panel of a military aircraft where the level of vibrations is especially high.

1. A display device comprising, as a minimum, a display cell (1), a frame (8) designed to receive the cell (1), and a system (11, 12, 13, 15, 16) for mechanically holding the cell (1) with respect to the frame (8), the device being characterized in that the mechanical holding system (11, 12, 13, 15, 16) comprises several stops (11, 12, 13) arranged in such a way as to define without maintaining a unique position of the cell (1) with respect to the frame (8) in a mean plane (XY) of the cell (1) and at least one block (15, 16) arranged in such a way as to be able, in combination with the stops (11, 12, 13), to maintain said position.

2. The display device as claimed in claim 1, characterized in that the display cell (1) is essentially flat and in that the direction (Z) of the thickness of the cell (1) is orthogonal to the mean plane (XY) of the cell (1).

3. The display device as claimed in claim 2, characterized in that the display cell (1) is a liquid crystal screen.

4. The display device as claimed in any one of the preceding claims, characterized in that there are three stops (11, 12, 13) and in that the projections of the stops (11, 12, 13) in the mean plane (XY) of the cell (1) are not aligned.

5. The display device as claimed in any one of the preceding claims, characterized in that the stops (11, 12, 13) all belong to the frame (8).

6. The display device as claimed in any one of the preceding claims, characterized in that each stop (11, 12, 13) is provided with a stop protector (14) made of semi-rigid material.

7. The display device as claimed in claim 6, characterized in that the semi-rigid material is plastic.

8. The display device as claimed in any one of the preceding claims, characterized in that the tightening axis (s) of each block (15, 16) is not parallel to the axis (b) of constraint of the cell (1) by said block (15, 16).

9. The display device as claimed in claim 8, characterized in that the tightening axis (s) of each block (15, 16) is more or less orthogonal to the axis (b) of constraint of the cell (1) by said block (15, 16).

10. The display device according to any one of the preceding claims, characterized in that the material of the block (15, 16) is plastic.

11. The display device as claimed in any one of the preceding claims, characterized in that the cell (1) is of essentially rectangular shape in its mean plane (XY), in that there are three stops (11, 12, 13), in that two (11, 12) of the stops are in contact with a first side (101) of the rectangle, the two stops (11, 12) being situated in the vicinity of two corners (105, 106) of the rectangle, and in that the third stop (13) is in contact with a second side (102) of the rectangle that is not parallel to the first side (101), the third stop (13) being situated in the vicinity of a third corner (107) of the rectangle.

12. The display device as claimed in claim 11, characterized in that the first side (101) is a long side of the rectangle while the second side (102) is a short side of the rectangle.

13. The display device as claimed in either of claims 11 and 12, characterized in that there are at least two of the blocks (15, 16) and in that two (15, 16) of the blocks are in contact with the third (103) and fourth (104) sides, respectively, of the rectangle, the two blocks (15, 16) being situated in the vicinity of the fourth corner (108) of the rectangle.

14. The display device as claimed in either of claims 11 and 12, characterized in that there is at least one of the blocks (15, 16) and in that one of the blocks is situated in the vicinity of the fourth corner (108) of the rectangle.

15. An aircraft instrument panel characterized in that it comprises at least one display device as claimed in any one of the preceding claims.
